(19) United States
(12) Patent Application Publication
(10) Pub. No.: US 2020/0024023 A1
(43) Pub. Date: Jan. 23, 2020

(54) RE-FILLABLE 2.5 GALLON CONTAINER TO USE, STORE, CARRY AND DISPENSE DIESEL EXHAUST FLUID

(71) Applicant: Randolph Odell Williams, Sr., Upper Chichester, PA (US)

(72) Inventor: Randolph Odell Williams, Sr., Upper Chichester, PA (US)

(21) Appl. No.: 16/422,621

(22) Filed: May 24, 2019

Related U.S. Application Data
(60) Provisional application No. 62/674,010, filed on May 20, 2018.

(51) Int. Cl. B65D 1/20; B65D 25/48

(52) U.S. Cl. CPC B65D 1/20; B67D 7/04; B65D 25/48

(57) ABSTRACT

A refillable filtered container to store and dispense Diesel Exhaust Fluid (DEF) and the like in a way which meets ISO 22241-3 standards.

### FIELD OF THE INVENTION

Environmental, this item is related to Diesel Exhaust Fluid (DEF) storage and use. It provides a solution to get Diesel Exhaust Fluid (DEF) from a bulk container to a vehicle while adhering to the ISO 22241-3 standards. (ISO 22241-3 describes best practice recommendations and requirements for the handling, transportation, and storage of AUS 32.) Diesel Exhaust Fluid (DEF) is used in Selective Catalytic Reduction (SCR) technology to remove harmful NOₓ emissions from diesel engines.

### BACKGROUND INFORMATION

The word “invention” will be used to identify the container, spout, hole and all other attachments used or referred to be used in and on this item.

Diesel Exhaust Fluid (DEF) is an emissions control liquid required by modem diesel engines. Diesel Exhaust Fluid (DEF) is used in Selective Catalytic Reduction (SCR) technology to remove harmful NOₓ emissions from diesel engines. It is injected into the exhaust stream. Diesel Exhaust Fluid (DEF) is never added to diesel fuel. It is a non-hazardous solution of 32.5% urea in 67.5% de-ionized water. Diesel Exhaust Fluid (DEF) is clear and colorless, and looks exactly like water. It has a slight smell of ammonia, similar to some home cleaning agents.

Diesel Exhaust Fluid (DEF) 2.5-gallon containers are sold all across America. They are portable and you can keep them in your vehicle. The problem is they are really expensive and are a one-time use item. This means the packaging, the spout and the container are all discarded after one use. Customers pay for this cost. This is not a problem if you have a diesel vehicle and only buy 1 container every three months. But large Diesel vehicles use one gallon of Diesel Exhaust Fluid (DEF) for every 300 miles they drive, this adds up quickly. This is the reason for bulk storage at trucking companies and other business across America. However, many companies are not able to position their bulk containers for convenient vehicle access. Even when they are, many obstacles could temporarily block access to the bulk container . . . like snow, building repairs, construction or the size of some diesel engine vehicles. So they refill non refillable 2.5 retail container to carry the product to their vehicles. These containers are dirty and left with the spouts off which allow the contents to crystalize diminishing its ability to perform properly. The spouts are often off because of the time it takes to get it off, then rethread the spouts back on. Over time it gets even more difficult to keep the spout on and prevent them from leaking as the thin container material weakens.

The spout and container mouth assemblies are intended for one time use, so they are not made of sturdy material or construction. This activity leads to an individual having a high level of contact directly with the Diesel Exhaust Fluid (DEF) and possible contamination to the container contents. This invention is faster, cleaner, environmentally conscious, convenient and most importantly complies with ISO 22241-3 standards.

This invention uses a hardened sturdy compliant container that is reusable when using the same product. This invention has a filtered outlet. The container has a fill hole placed to receive a standard nozzle and is protected by a door which closes to keep out any foreign material. Using a hole covering method is faster because it eliminates the need to unscrew then re-attach a spout. When not in use, the spout has a cap to keep air and contaminants out. This inventions method of use is safer because it limits the individuals' exposure to the Diesel Exhaust Fluid (DEF). It also offers options for storing the Diesel Exhaust Fluid (DEF) in the container in a way that won't spillover out if the container is turned over.

Each time an unapproved container is reused, the spout must be removed, it is then most likely placed on the ground or some other unclean surface. Contaminants can damage the Selective Catalytic Reduction (SCR) system and cause costly repairs. The individual who removed the spout now has several opportunities for direct contact. Once on the hands it can get on other surfaces, in food or in the eyes from rubbing. Some material which comes in contact with the Diesel Exhaust Fluid (DEF) could become discolored, damaged or tainted. The rear door covering the fill hole can be opened with just the thumb and/or a push which makes it very convenient . . . and it closed just as easily. So one hand opens the rear fill hole door then sturdies the container while the other hand refills the container. Removing the need to touch the spout sit it down then re-attach it. This saves time and limits exposure to the Diesel Exhaust Fluid (DEF).

In addition, once refilled a driver can safely transport and store Diesel Exhaust Fluid (DEF) in this container and even keep one in the vehicle for convenient access while on the road. Until now the only option is to purchase expensive 2.5 gallon containers while away, or find a truck stop that could be out of the way or in the other direction.

Not purchasing 2.5 gallon containers made of plastic and cardboard to use and then discard is much better for the environment.

### BRIEF SUMMARY OF INVENTION

Some embodiments of the invention are illustrated as an example and are not limited by the figures of the accompanying drawings, in which like references may indicate similar elements to be used. The terms “and/or” includes any and all combinations of one or more of the associated listed items. As used the singular forms “a”, “an” and “the” are intended to include the plural forms as well as the singular forms unless indicated otherwise clearly. It is further understood that the presence of stated features, steps, operations, elements and/or components do not preclude the presence or addition of one or more other features, steps, operations and elements. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

Diesel Exhaust Fluid (DEF) is a liquid which should be kept pure and enclosed to prevent contamination and crystallization. This container is used to carry Diesel Exhaust Fluid (DEF) from a bulk container to a vehicle. It meets the ISO 22241-3 standards for storing and transporting Diesel Exhaust Fluid (DEF).

Use: Invention has a covered fill hole to accept a nozzle or other filling apparatus to fill with the invention with Diesel Exhaust Fluid (DEF) that can then be carried to a vehicle or other equipment using a Selective Catalytic Reduction (SCR) and dispensed through the inventions filtered spout. The invention can then be refilled with Diesel Exhaust Fluid (DEF) and set aside for storage until it is needed again.

### DESCRIPTION OF DRAWINGS

FIG. 1 is a complete picture of the container, with an exploded view of all possible components, design and locations for such. The main components are, a container, a spout and a rear door assembly.

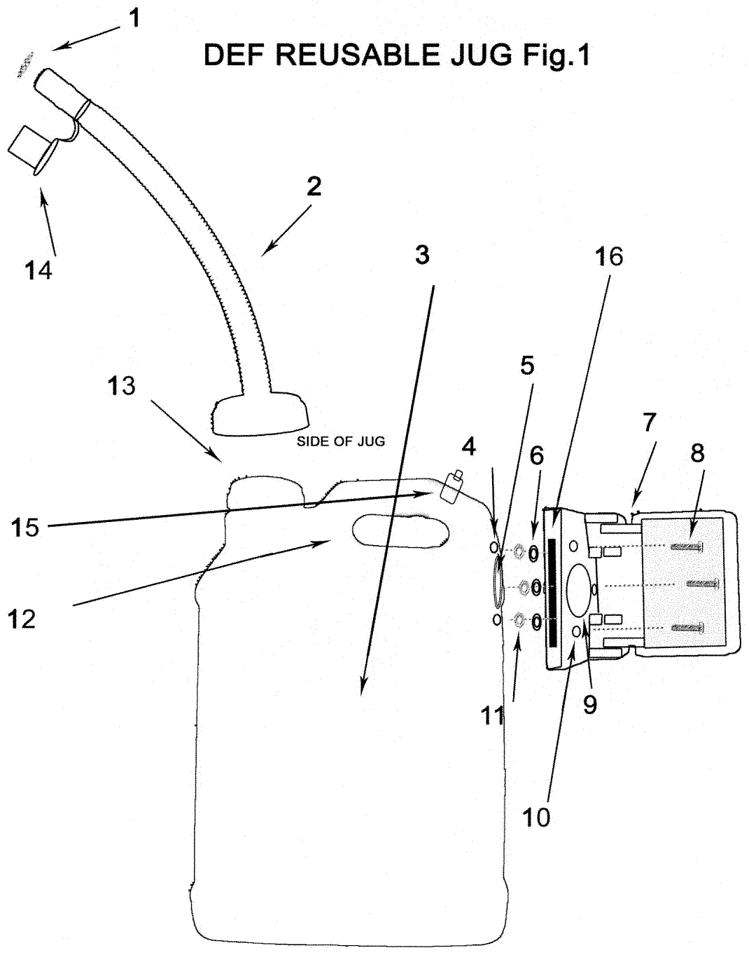

Some embodiments of the invention are illustrated as an example and are not limited by the figures of the accompanying drawings, in which like references may indicate similar elements to be used.

(1) Illustration of the 100 Micron FILTER various embodiments described below

(2) Illustration of the pour SPOUT various embodiments described below

(3) Illustration of the CONTAINER various embodiments described below

(4) Illustration of SMALL SCREW HOLES various embodiments described below

(5) Illustration of The REAR FILL HOLE in container various embodiments described below

(6) Illustration of WASHERS various embodiments described below

(7) Illustration of the REAR DOOR ASSEMBLY various embodiments described below

(8) Illustration of the SCREWS various embodiments described below

(9) Illustration of FILL HOLE in rear door assembly various embodiments described below

(10) Illustration of SMALL SCREW HOLES in rear door assembly various embodiments described below

(11) Illustration of NUTS various embodiments described below

(12) Illustration of container HANDLE various embodiments described below

(13) Illustration of the MOUTH of the container various embodiments described below

(14) Illustration of the spout PROTECTIVE CAP various embodiments described below

(15) Illustration of VENT system various embodiments described below

(16) Illustration of MAGNET device various embodiments described below

### DETAILED DESCRIPTION OF INVENTION

This invention was born from a need to transport Diesel Exhaust Fluid (DEF), but this invention could be used for other harmless liquids that are not regulated and uses a nozzle for dispensing. This container and all its components is assumed to use only approved material per the ISO 22241-3 standard of acceptable material to store and handle Diesel Exhaust fluid (DEF).

The container 3 made of some type of plastic or metal design is used to carry Diesel Exhaust fluid (DEF) safely while preventing contamination. It shall be natural in color or if metal have a visible strip to see the level of the contents inside and hold approximately 2.5 Gal. of liquid (10L) more or less. The container 3 should have a handle 12 or some other means of picking up the container 3 to move it safely with liquid and other attachments adhered. This container 3 will be refilled using a hole 9 in the rear, side or top in a size which limits the possibility of foreign objects being introduced, by being just big enough for a standard size Diesel Exhaust Fluid (DEF) dispensing nozzle. This hole 9 in the rear, side or top should be covered by a protective door, lid, flap or mechanism 7 that is spill proof and air tight once closed. This protective door, lid, flap or mechanism 7 will cover the hole 9 in rear, side or top once use is finished. Inside of this protective door, lid, flap or mechanism 7 will be a magnet activated device 16 of some type located inside the container 3 and/or built inside of the protective door, lid, flap or mechanism 7, to allow refilling the container 3 at a truck stop, gas station or any time refilling is done using a magnetically activated nozzle.

This door, lid, flap or mechanism 7 item which will cover and protect the fill hole 5 in rear, side or top of the container 3 should be attached to the container 3 in the rear, side or top the with screws and/or fasteners 8 of some type, washers 6 and/or nuts 11. Matching screw holes 4 & 10 in the container 3 will align if needed for connection of the door, lid, flap or mechanism 7 to the container 3. The fill hole door, lid, flap or mechanism 7 may also be a part of the containers 3 mold, shape and/or form to serve the purpose described above.

The mouth 13 of the container 3 should be an industry standard size that will accept a spout 2 or cap. The spout 2 must be long enough to access vehicles fill holes in large and small capacity use vehicles. The spout 2 should have a filter 1 to remove any foreign material from the container 3 while pouring. This filter 1 may or may not be in the tip, center or base of the spout 2. The tip of the spout 2 should be protected with a lid, cap 14 or an automatic mechanism which closes and/or can be closed and make the container 3 airtight after each use. This pouring spout lid 14 may or may not be in inside, outside, the tip, center or base of the spout 2. The rear, side or back of the container 3 will have venting system 15 of some sort that may be part of the container 3 mold and/or an added item made of plastic, rubber or metal design. This vent 15 may have the ability to only let air in when needed pouring, and shut off after pouring is complete and/or to allow the container 3 to breath by letting air out when needed.

How It Will Be Used

This invention will assist people to safely, cleanly, quickly and environmentally friendly transport Diesel Exhaust Fluid (DEF) from a bulk container to their vehicles. With a cap/lid, the Diesel Exhaust Fluid (DEF) will not spill out or be exposed to air while being moved or stored. The size of the container is great for holding with two hands easily. With a small fill hole, the Diesel Exhaust Fluid (DEF) has less chance of spilling and letting in contaminants that may easily fall into a bigger opening when filling. If something should be introduced into the container, it will be caught by the filter on the container. Once filled the Diesel Exhaust Fluid (DEF) can be carried to a vehicle and the vehicles tank can be refilled.

What is claimed is:

1. A re-usable & re-fillable container used to store, carry and dispense Diesel Exhaust Fluid (DEF) in a way that is ISO 22241-3 compliant. Comprising of:
a. Fill hole with cover
b. filtering system
c. magnetic nozzle trigger
d. venting system
e. spout
